(19) United States
(12) Patent Application Publication
(10) Pub. No.: US 2011/0314059 A1
(43) Pub. Date: Dec. 22, 2011

(54) MOBILE SEARCH METHOD AND APPARATUS

(75) Inventor: Hanqiang HU, Shenzhen (CN)

(73) Assignee: Huawei Technologies Co., Ltd., Shenzhen (CN)

(21) Appl. No.: 13/219,058

(22) Filed: Aug. 26, 2011

Related U.S. Application Data
(63) Continuation of application No. PCT/CN2009/074758, filed on Nov. 5, 2009.

(30) Foreign Application Priority Data
Feb. 27, 2009 (CN) 200910118632.7
Jul. 1, 2009 (CN) 200910140119.8

(51) Int. Cl. G06F 17/30

(52) U.S. Cl. 707/771; 707/E17.014

(57) ABSTRACT

A mobile search method and apparatus are provided. The method includes: receiving a search request, in which the search request includes one or more search keywords; calculating a score of each search category domain, in which the score is a score of any item or a comprehensive score of multiple items of the following: similarity between the search request and the search category domain, a mass search rate of the search category domain corresponding to the search request, and an individualized user interest score of the search category domain, and the mass search rate is the number of mass searches or the number of mass search result clicks; and selecting one or more of search category domains according to the score of each of the search category domains to search for the search keywords. Therefore, through the method and apparatus, an individualized accurate search result can be provided for a user.

### CROSS-REFERENCE TO RELATED APPLICATIONS

This application is a continuation of International Application No. PCT/CN2009/074758, filed on Nov. 5, 2009, which claims priority to Chinese Patent Application No. 200910118632.7, filed on Feb. 27, 2009 and Chinese Patent Application No. 200910140119.8, filed on Jul. 1, 2009, all of which are hereby incorporated by reference in their entireties.

### FIELD OF THE INVENTION

The present invention relates to mobile communication technologies, and in particular, to a mobile search method and apparatus.

### BACKGROUND OF THE INVENTION

Currently, mobile search, as a combination of search engines and mobile communications which are currently two hot fields of the information industry, has become a new bright spot and growth point of mobile value-added services. The framework of the mobile search is an open platform based on meta-search, and integrates capabilities of many specialized/vertical search engines, so as to provide a comprehensive search capability for users.

When using the mobile search, a user usually searches directly after inputting a search keyword without selecting any category domain for the search. Therefore, regarding how to correctly understand a search intention of a user to provide an individualized accurate search result for the user, no desirable solution exists in the prior art.

### SUMMARY OF THE INVENTION

The embodiments of the present invention provide a mobile search method and apparatus. The method and apparatus can provide an individualized accurate search result for a user.

An embodiment of the present invention provides a mobile search method, where the method includes:

receiving a search request, in which the search request includes one or more search keywords;

calculating a score of each search category domain, in which the score is a score of any item or a comprehensive score of multiple items of the following: similarity between the search request and the search category domain, a mass search rate of the search category domain corresponding to the search request, and an individualized user interest score of the search category domain; and

selecting one or more of search category domains according to the score of each of the search category domains to search for the search keywords.

An embodiment of the present invention provides a mobile search apparatus, where the apparatus includes:

a receiving unit, configured to receive a search request, in which the search request includes one or more search keywords;

a calculation unit, configured to calculate a score of each search category domain, in which the score is a score of any item or a comprehensive score of multiple items of the following: similarity between the search request and the search category domain, a mass search rate of the search category domain corresponding to the search request, and an individualized user interest score of the search category domain;

a selection unit, configured to select one or more of search category domains according to the score of each of the search category domains; and

a search unit, configured to search for the search keywords by using the one or more search category domains selected by the selection unit.

According to the mobile search method and apparatus provided by the embodiments of the present invention, a mass interest of a user and an individualized interest of the user are analyzed to determine an individualized query classification of the user, so as to provide an individualized accurate search result for the user.

### BRIEF DESCRIPTION OF THE DRAWINGS

FIG. 1 is a flow chart of a mobile search method according to an embodiment of the present invention;

FIG. 2 is an implementation flow chart of a mobile search method according to an embodiment of the present invention;

FIG. 3 is another implementation flow chart of a mobile search method according to an embodiment of the present invention;

FIG. 4 is another implementation flow chart of a mobile search method according to an embodiment of the present invention;

FIG. 5 is another implementation flow chart of a mobile search method according to an embodiment of the present invention;

FIG. 6 is a schematic structural diagram of a mobile search apparatus according to an embodiment of the present invention;

FIG. 7 is a specific schematic structural diagram of a mobile search apparatus according to an embodiment of the present invention;

FIG. 8 is another specific schematic structural diagram of a mobile search apparatus according to an embodiment of the present invention;

FIG. 9 is another specific schematic structural diagram of a mobile search apparatus according to an embodiment of the present invention;

FIG. 10 is a schematic structural diagram of an interest model extraction subunit of the apparatus shown in FIG. 9;

FIG. 11 is another schematic structural diagram of the interest model extraction subunit of the apparatus shown in FIG. 9; and

FIG. 12 is another specific schematic structural diagram of a mobile search apparatus according to an embodiment of the present invention.

### DETAILED DESCRIPTION OF THE EMBODIMENTS

To make a person skilled in the art understand the solutions of the embodiments of the present invention in a better way, the embodiments of the present invention are further described in detail in the following with reference to the accompanying drawings and implementations.

In a mobile search method and apparatus according to the embodiments of the present invention, for a search request of a user, an individualized query classification of the user is determined by analyzing a mass interest corresponding to the user and an individualized interest of the user. Specifically, a score of each search category domain is calculated, in which the score is a score of any item or a comprehensive score of multiple items of the following: similarity between the search request and the search category domain, a mass search rate of the search category domain corresponding to the search request, and an individualized user interest score of the search category domain; and the mass search rate is the number of mass searches or the number of mass search result clicks. Then, one or more of search category domains are selected according to the score of each of the search category domains to search for a query keyword, thereby providing an individualized accurate search result for the user.

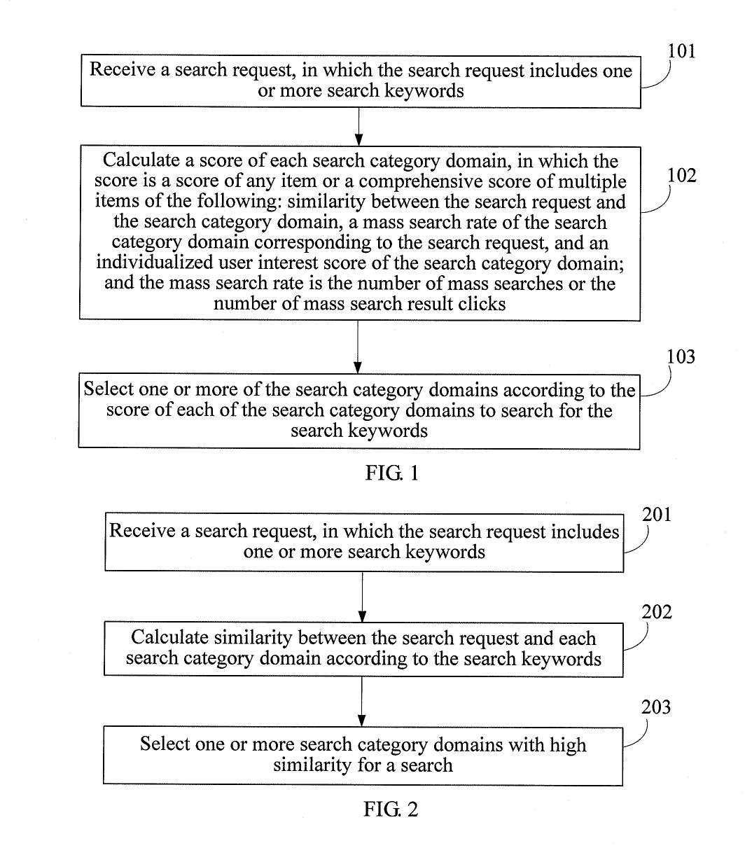

FIG. 1 is a flow chart of a mobile search method according to an embodiment of the present invention.

Step 101: Receive a search request, in which the search request includes one or more search keywords.

Step 102: Calculate a score of each search category domain. The score is a score of any item or a comprehensive score of multiple items of the following: similarity between the search request and the search category domain, a mass search rate of the search category domain corresponding to the search request, and an individualized user interest score of the search category domain. The mass search rate is the number of mass searches or the number of mass search result clicks.

Step 103: Select one or more of search category domains according to the score of each of the search category domains to search for the search keywords.

According to the embodiment of the present invention, determining the individualized query classification of the user may be performed in multiple manners. For example, one or more search category domains with high similarity may be selected for a search according to the similarity between the search request and the search category domain; or, one or more search category domains with a high mass search rate may be selected for a search according to the mass search rate of the search category domain corresponding to the search request; or, one or more search category domains with a high individualized user interest score may be selected for a search according to the individualized user interest score of the search category domain. Definitely, the foregoing items may also be taken into account in a comprehensive manner to calculate the comprehensive score of each search category domain, and one or more search category domains with a high comprehensive score may be selected for a search. Detailed description is provided in the following by using respective examples.

FIG. 2 is an implementation flow chart of a mobile search method according to an embodiment of the present invention.

In this embodiment, a search category domain is selected for a search according to similarity between a search request and search category domains, so as to provide an individualized accurate search result for a user.

Step 201: Receive a search request, in which the search request includes one or more search keywords.

Step 202: Calculate similarity between the search request and each search category domain according to the search keywords.

The search keywords in the search request may be set with corresponding weights, and a query vector Query (q1, q2, . . . qn′) is generated by using the weights of the search keywords, where q1, q2, . . . qn′ are the weights corresponding to the search keywords. Specifically, all of the keywords may be set with the same weight, such as weight=1; or, different keywords may be set with different weights, for example, the first keyword is set with the maximum weight, such as weight=1, the middle keyword is set with a medium weight, such as 0.5<weight<1, and the last keyword is set with the minimum weight, such as weight=0.5.

A domain vector corresponding to the search category domain is generated by using the weights of words of a search category domain. For example, all topic words and relevant words of each search category domains are set with certain weights, and a domain vector Domain (t1, t2, . . . , tn) corresponding to the search category domain is generated by the weights of the topic words and relevant words, where t1, t2, . . . , tn are the weights of the words of the search category domain. The similarity between the search request and the search category domain is acquired by calculating the query vector and the domain vector.

The similarity between the vector Domain (t1, t2, . . . , tn) and the vector Query (q1, q2, . . . , qn′) is calculated by using the following formula:

Sim(Query(q1, q2, . . . , qn′), Domain(t1, t2, . . . , tn))=(q1*ti1+q2*ti2+ . . . +qn′*tin′)/(\sqrt{q1²+q2²+ . . . +qn′²}*\sqrt{tᵢ₁²+tᵢ₂²+ . . . +tᵢₙ′²}) (1).

In the formula, ti1, ti2, . . . , tin′ are respectively weights in the Domain (t1, t2, . . . , tn) corresponding to the words that are the same as the search keywords corresponding to the weights q1, q2, . . . , qn.

Assuming that the number of the search category domains is m, the corresponding domain vectors are respectively Domain1 (t1, t2, . . . , tn), Domain2 (t1, t2, . . . , tn), . . . , Domainm (t1, t2, . . . , tn), the similarity between the vector Query (q1, q2, . . . , qn′) and each of the domain vectors is respectively calculated according to formula (I).

Step 203: Select one or more search category domains with high similarity for a search.

In this embodiment, the topic word and the relevant word in each search category domain and the weight of each word can be set in multiple manners.

1. Setting is Performed Manually.

The topic word is set with the maximum weight, the strongly relevant word is set with a medium weight, and the weakly relevant word is set with the minimum weight.

For example, the topic word (such as “Sichuan Cuisine” in a search category domain of catering) is set with a weight equal to 1, the strongly relevant word (such as “spicy” in the search category domain of catering) is set with a weight equal to 0.8, and the weakly relevant word (such “delicious” in the search category domain of catering) is set with a weight equal to 0.5.

2. Setting is Performed in an Automatic Learning Manner.

The specific process is as follows:

(1). Acquire a training text language material sample corresponding to each search category domain.

(2). Perform word cutting on the language material sample to generate a vocabulary of the search category domain.

(3). Calculate the weight of each word in the vocabulary. The weight of each word is TF*GIDF, in which TF is an overall word occurrence frequency of the word in all of the language material samples of the search category domain, GIDF is a global inverse document frequency, and GIDF=log(1+N/GDF), where N is the total number of all language material samples of all search category domains, and GDF is a global language material sample frequency, that is, the number of all of the language material samples of all search category domains that include the word.

(4). Determine the topic word and the relevant word of the search category domain according to the weight of each word.

Assuming that the number of words in a vocabulary of a search category domain is n, corresponding weights are T1, T2, Tn, and T1>T2> . . . Tn, it may be regarded that the word corresponding to T1 is a topic word, and the other words are relevant words.

Furthermore, all words in the vocabulary may be divided into sets of different levels according to the weights, the set of each of the levels is set with a final score, and the final score of each of the levels is used as the weight of each word of the level. For example, the number of the levels is L, the first level is set with the maximum score, a medium level is set with a medium score, and the L^{th} level is set with the minimum score. Therefore, a domain vector of a corresponding search category domain is generated by the words in the vocabulary and the final scores.

Definitely, the embodiment of the present invention is not limited to the foregoing setting manners, and the topic word and the relevant word in each search category domain and the weight of each of the words may also be set in other manners which are not described herein.

In the mobile search method according to the embodiment of the present invention, for the search request of the user, the similarity between the query vector of the search request and the domain vector of each search category domain is calculated, and one or more search category domains with high similarity are selected for a search, so as to determine an individualized query classification for the user, and provide an individualized accurate search result for the user.

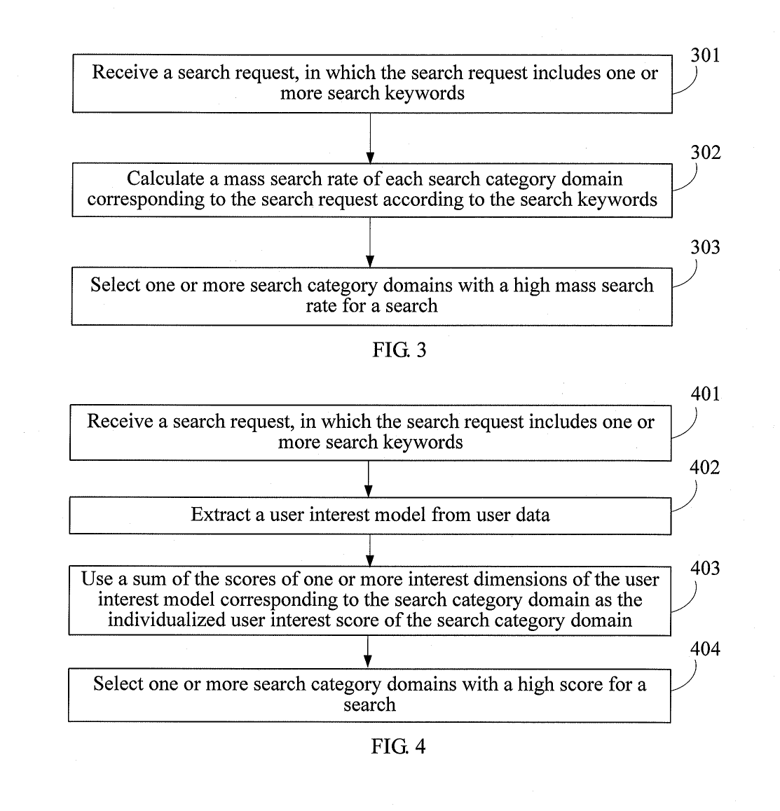

FIG. 3 is another implementation flow chart of a mobile search method according to an embodiment of the present invention.

In this embodiment, a search category domain is selected for a search according to a mass search rate of the search category domain corresponding to a search request, so as to provide an individualized accurate search result for a user.

Step 301: Receive a search request, in which the search request includes one or more search keywords.

Step 302: Calculate a mass search rate of each search category domain corresponding to the search request according to the search keywords.

Step 303: Select one or more search category domains with a high mass search rate for a search.

In the embodiment of the present invention, the mass search rate specifically may be the number of mass searches or the number of mass search result clicks.

Processes of calculating the number of mass searches and the number of mass search result clicks of each of the search category domains corresponding to the search request are described in detail in the following.

The process of calculating the number of mass searches of a search category domain corresponding to the search request is as follows.

(1): Calculate the total number of mass searches of a search category domain corresponding to each keyword in the search request.

For a search request including a keyword of the search request, the total number of times of selecting a search category domain for a search by all users may be acquired according to a historical record, and the total number of times is used as the total number of times of searching the search category domain by the masses corresponding to the keyword, that is, the total number of mass searches corresponding to the search category domain.

(2): Use a sum of the total numbers of mass searches of the search category domain corresponding to all of the keywords of the search request as the total number of mass searches of the search category domain corresponding to the search request.

Likewise, the process of calculating the number of mass search result clicks of a search category domain corresponding to the search request is as follows.

(1): Calculate the total number of mass search result clicks of a search category domain corresponding to each keyword in the search request.

For search requests including a keyword of the search request, the total number of clicks of all users on a search result of selecting a search category domain for a search may be acquired according to a historical record, and the total number is used as the total number of clicks of the masses on the search result of the search category domain corresponding to the keyword, that is, the total number of mass search result clicks corresponding to the search category domain.

(2): Use a sum of the total numbers of mass search result clicks of the search category domain corresponding to all of the keywords of the search request as the total number of mass search result clicks of the search category domain corresponding to the search request.

In the mobile search method according to the embodiment of the present invention, for the search request of the user, the mass search rate of each of the search category domains corresponding to the search request is calculated, and one or more search category domains with a high mass search rate are selected for a search, so as to determine an individualized query classification for the user, and provide an individualized accurate search result for the user.

FIG. 4 is another implementation flow chart of a mobile search method according to an embodiment of the present invention.

In this embodiment, a search category domain with a high score is selected for a search according to an individualized user interest score of the search category domain, so as to provide an individualized accurate search result for a user.

Step 401: Receive a search request, in which the search request includes one or more search keywords.

Step 402: Extract a user interest model from user data.

The user interest model is a vector generated by scores of multiple interest dimensions according to user data, for example IM (I1, I2, . . . , In), where Ii is a score of an i^{th} interest dimension of the user. The user interest model may be extracted from user individualized data (such as a static file, historical data of searches and clicks, presence service information, and local information). Corresponding user interest models may also be extracted from the user individualized data in advance, and saved. When needed, a required user interest model is directly extracted from the saved user interest models.

The user interest model may be a static interest model or a dynamic interest model, and definitely may also be an interest model generated by combining a static interest model and a dynamic interest model.

A user static interest model can be extracted from a user static file, which can specifically be achieved in the following two manners:

(1) A sum of word occurrence frequencies of all words in the user static file that belong to each interest dimension is calculated, and the sum is used as a score corresponding to the interest dimension, and scores of all of the interest dimensions are used as a vector to generate the user interest model.

(2) A score of similarity between the user static file and each interest dimension is calculated, and the score is used as a score corresponding to the interest dimension, and scores of all of the interest dimensions are used as a vector to generate the user interest model.

A user dynamic interest model is extracted from user data, which can specifically be achieved in the following two manners:

(1) A sum of word occurrence frequencies of all words in a historical record of searches and clicks of the user that belong to each interest dimension is calculated, and the sum is used as a score corresponding to the interest dimension, and scores of all of the interest dimensions are used as a vector to generate the user dynamic interest model.

(2) A score of similarity between a historical record of searches and clicks and each interest dimension is calculated, and the score is used as a score corresponding to the interest dimension, and scores of all of the interest dimensions are used as a vector to generate the user dynamic interest model.

The interest model generated by combining a static interest model and a dynamic interest model may be as follows:

(1) The static interest model and the dynamic interest model each are normalized, and then a sum of one or more normalized static interest models and one or more normalized dynamic interest models is calculated, and the sum is used as the user interest model.

(2) A weighted sum of one or more static interest models and one or more dynamic interest models is calculated, and then the weighted sum is normalized, and a normalized result is used as the user interest model.

Step 403: Use a sum of the scores of one or more interest dimensions of the user interest model corresponding to the search category domain as the individualized user interest score of the search category domain.

Step 404: Select one or more search category domains with a high score to search for the search keywords.

For example, user interests are represented by n dimensions, such as news, sports, entertainments, finance and economics, science and technology, real estate, games, females, forums, weather, commodities, home appliances, music, readings, blogs, mobile phones, military, education, travel, multimedia messages, color ring back tones, catering, civil aviation, industry, agriculture, computers, and geography. The user interest model is a vector W (r1, r2, r3, . . . , rn) generated by scores of the interest dimensions of a user.

When the user interest model is extracted from the user individualized data, the user interest model may be extracted from the user static file or from the historical data of searches performed by the user.

The user interest model W1 may be extracted from the user static file in the following manners:

(1) W1=(p1, p2, p3, . . . , pn), where pi is a sum of word occurrence frequencies of all words in the static file that belong to an i^{th} interest dimension.

(2) W1=(p1, p2, p3, . . . , pn), where pi is a score of similarity between the static file and an i^{th} interest dimension.

The process of calculating the similarity pi between the static file and an interest dimension is as follows.

(a). Extract a characteristic vocabulary of a classifier, which specifically includes the following steps:

(i). For each of the interest dimensions of the user, collect a corresponding language material set respectively to generate a corpus.

(ii). Perform word cutting on the corpus to form a series of terms.

(iii). Judge whether the term after the word cutting is a characteristic word, which may specifically be performed by using a Chi-square (CHI) statistic algorithm:

$${χ}^{2} ( t , c ) = \frac{N \cdot {( AD - BC )}^{2}}{( A + C ) ( B + D ) ( A + B ) ( C + D )} .$$

In the algorithm, the meanings of the parameters are as follows: t: a term; c: a classification; N: the total number of training texts; A: the number of the training texts belonging to c and including t; B: the number of the texts not belonging to c but including t; C: the number of the texts belonging to c but not including t; and D: the number of the texts neither belonging to c nor including t. If both C and D are equal to 0, χ²(t,c)=0.

A CHI value of the term t regarding an entire training set may be defined as: χ_{avg}²(t)=ΣP(c)χ²(t,c) or χₘₐₓ²(t)=max χ² (t, c), and a term corresponding to a value smaller than a given threshold may not be considered as a characteristic word.

The process of calculating P(c) is as follows.

It is assumed that classifications are C₁, C₂, . . . , Cₙ.

Accordingly,

$$P ( {C}_{i} ) = \frac{N ( {C}_{i} )}{N} ,$$

where N(Cᵢ) is the number of the training texts included by the classification Cᵢ.

Alternatively,

$$P ( {C}_{i} ) = \frac{M ( {C}_{i} )}{M} ,$$

where M(Cᵢ) is the total number of terms included in all of the training texts of the classification Cᵢ, and M is the total number of terms included in all of the training texts.

Finally, acquired characteristic terms are recorded as t1, t2, . . . , tn.

Definitely, the judging whether the term after the word cutting is a characteristic word is not limited to the CHI algorithm, and may also be performed by using other algorithms, such as χ²(t,c)=|AD−BC|.

(b). Acquire a characteristic vector Wi=(wi1, wi2, . . . , wii, . . . , win) of the i^{th} interest dimension according to the characteristic words acquired in step (a), where wii is a weight of the characteristic word ti in the i^{th} interest dimension.

Wii=TFi*log(1+N/GDFi), where TFi is a word occurrence frequency of the characteristic word ti in all language materials that belong to the i^{th} interest dimension, N is the number of the characteristic word ti in documents of all language materials of all of the interest dimensions, and GDFi (a global document frequency) is the number of documents of all of the language materials of all of the interest dimension that include the characteristic word ti.

(c). Acquire a characteristic vector S=(s1, s2, . . . , sn) of a user static file according to the characteristic words acquired in step (a), where si is a weight of the characteristic word ti in the user static file.

si is equal to a word occurrence frequency of the characteristic word ti in the static file.

(d). Calculate similarity between the vector of the user static file and the characteristic vector Wi of the i^{th} interest dimension to acquire a score pi of the similarity,

Pi=Wi*S/|Wi|*|S|=(wi1*s1+wi2*s2+ . . . +win*sn)/(\sqrt{wi1²+wi2²+ . . . +win²}*\sqrt{s1²+s2²+ . . . +sn²}).

The user interest model W2 may be extracted from historical data of searches performed by the user in the following manners.

W2=d1+d2+d3+ . . . dm, where di is an interest model vector corresponding to a clicked document of the user.

There are two methods for acquiring the interest model vector corresponding to a clicked document:

(1) di=(t1, t2, t3, . . . , tn), when the user newly clicks a document, tj is a sum of word occurrence frequencies of all words in the document that belong to a i^{th} interest dimension.

(2) di=(t1, t2, t3, . . . , tn), where di is a score of similarity between a document and an i^{th} interest dimension. The process of calculating di is as follows:

(a). Extract a characteristic vocabulary of a classifier, which specifically includes the following steps:

(i). For each of the interest dimensions of the user, collect a corresponding language material set respectively to generate a corpus.

(ii). Perform word cutting on the corpus to form a series of terms.

(iii). Judge whether the term after the word cutting is a characteristic word, which may specifically be performed by using a CHI algorithm:

$${χ}^{2} ( t , c ) = \frac{N \cdot {( AD - BC )}^{2}}{( A + C ) ( B + D ) ( A + B ) ( C + D )} .$$

In the algorithm, the meanings of the parameters are as follows: t: a term; c: a classification; N: the total number of training texts; A: the number of the texts belonging to c and including t; B: the number of the texts not belonging to c but including t; C: the number of the texts belonging to c but not including t; and D: the number of the texts neither belonging to c nor including t; and if both C and D are equal to 0, χ²(t, c)=0.

A CHI value of the term t regarding an entire training set may be defined as: χ_{avg}²(t)=ΣP(c)χ²(t, c) or χₘₐₓ²(t)=max χ²(t,c), and a term corresponding to a value smaller than a given threshold may not be considered as a characteristic word.

It is assumed that classifications are C₁, C₂, . . . , Cₙ, and the process of calculating P(c) is as follows:

$$P ( {C}_{i} ) = \frac{N ( {C}_{i} )}{N} ,$$

where N(Cᵢ) is the number of the training texts included by the classification Cᵢ.

Alternatively,

$$P ( {C}_{i} ) = \frac{M ( {C}_{i} )}{M} ,$$

where M(Cᵢ) is the total number of terms included in all of the training texts of the classification Cᵢ, and M is the total number of terms included in all of the training texts.

Finally, acquired characteristic terms are t1, t2, . . . , tn.

Definitely, the judging whether the term after the word cutting is a characteristic word is not limited to the CHI algorithm, and may also be performed by using other algorithms, such as χ²(t,c)=|AD−BC|.

(b). Acquire a characteristic vector Wi=(wi1, wi2, . . . , wii, . . . , win) of the i^{th} interest dimension according to the characteristic words acquired in Step (a), where wii is a weight of the characteristic word ti in the i^{th} interest dimension.

Wii=TFi*log(1+N/GDFi), where TFi is a word occurrence frequency of the characteristic word ti in all language materials that belong to the i^{th} interest dimension, N is the number of the characteristic word ti in documents of all language materials of all of the interest dimensions, and GDFi (a global document frequency) is the number of documents of all of the language materials of all of the interest dimension that include the characteristic word ti.

(c). Acquire a characteristic vector V=(v1, v2, . . . , vn) of a document according to the characteristic words acquired in step (a), where vi is a weight of the characteristic word ti in the document, and vi is equal to a word occurrence frequency of the characteristic word ti in the document.

(d). Calculate similarity between the characteristic vector v of the document and the characteristic vector Wi of the i^{th} interest dimension to acquire a score di of the similarity:

di=Wi*V/|Wi|*|V|=(wi1*v1+wi2*v2+ . . . +win*vn)/(\sqrt{wi1²+wi2²+ . . . +win²}*\sqrt{v1²+v2²+ . . . +vn²}).

If a user evaluates a clicked document, and the evaluation is high, the di vector is multiplied by a positive constant c, which means that the importance of the document is increased, that is, di=c*di=(c*ti, c*t2, c*t3, c*tn); and if the evaluation is low, the di vector is multiplied by the reciprocal of the positive constant c, which means that the importance of the document is decreased, that is, di=1/c*di=(1/c*ti, 1/c*t2, 1/c*t3, 1/c*tn).

After a certain period of time, the value of tj automatically decreases by a certain percent, which means that the importance of the document decreases as time goes by, till the value of tj is decreased to be zero after a long period of time, in which case di may be deleted from the historical record.

W1 and W2 each are normalized to acquire the user interest model W=r1*W1+r2*W2, where r1+r2=1.

In the mobile search method according to the embodiment of the present invention, for the search request of the user, the individualized user interest score of each of the search category domains is calculated, and one or more search category domains with a high score are selected for a search, so as to determine an individualized query classification for the user, and provide an individualized accurate search result for the user.

In the foregoing embodiments, when the search category domain is selected, the similarity between the search request and the search category domain, the mass search rate of the search category domain corresponding to the search request, and the individualized user interest score of the search category domain are respectively used as a basis for selecting the search category domain, so as to determine an individualized query classification of the user, and provide an individualized accurate search result for the user.

According to an embodiment of the present invention, any two or more of the foregoing items may also be taken into account in a comprehensive manner to calculate a comprehensive score of each of the search category domains, and one or more search category domains with a high comprehensive score may be selected for a search. An embodiment of the present invention is described in detail in the following by using an example, in which the foregoing three items are taken into account in a comprehensive manner, and are used as a basis for selecting a search category domain.

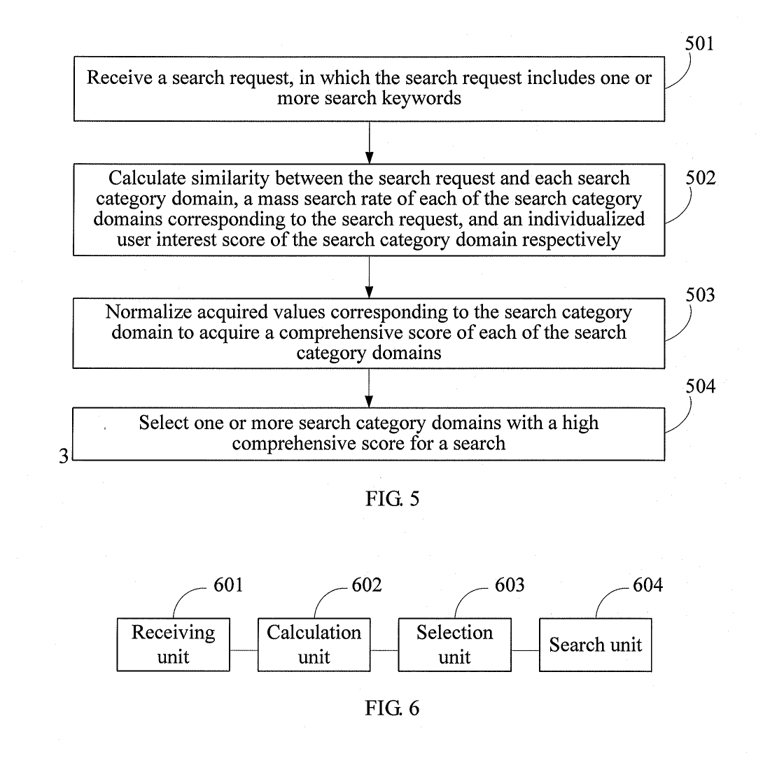

FIG. 5 is another implementation flow chart of a mobile search method according to an embodiment of the present invention.

Step 501: Receive a search request, in which the search request includes one or more search keywords.

Step 502: Calculate similarity between the search request and each search category domain, a mass search rate of each of the search category domains corresponding to the search request, and an individualized user interest score of the search category domain respectively.

Step 503: Normalize acquired values corresponding to the search category domain to acquire a comprehensive score of each of the search category domains.

For example, the similarity between the search request and a search category domain is calculated and normalized to acquire a value Score1.

The mass search rate of the search category domain corresponding to the search request is calculated and normalized to acquire a value Score2.

The individualized user interest score of the search category domain is calculated and normalized to acquire a value Score3.

The comprehensive score of the search category domain is calculated, which is equal to r1*score1+r2*score2+r3*score3, where r1 is a weight value of Score1, r2 is a weight value of Score2, r3 is a weight value of Score3, and r1+r2+r3+r4=1.

The comprehensive score may also be calculated in other manners.

For example, the comprehensive score is equal to score1*score2*score3.

Or, the comprehensive score is equal to (score1+score2+score3)/3.

Step 504: Select one or more search category domains with a high comprehensive score for a search.

In view of the foregoing, in the embodiment of the present invention, multiple factors are taken into account in a comprehensive manner to determine an individualized query classification of the user, the comprehensive score of each of the search category domains is calculated, and one or more search category domains with a high comprehensive score are selected for a search, thereby providing an individualized accurate search result for the user.

Those of ordinary skill in the art should understand that all or a part of the steps in the method according to the embodiments of the present invention can be implemented by a program instructing relevant hardware, and the program may be stored in a computer readable storage medium, such as a ROM/RAM, a magnetic disk, or an optical disk.

An embodiment of the present invention further provides a mobile search apparatus, and

FIG. 6 is a schematic structural diagram of the apparatus.

In this embodiment, the apparatus includes: a receiving unit 601, a calculation unit 602, a selection unit 603, and a search unit 604.

The receiving unit 601 is configured to receive a search request, in which the search request includes one or more search keywords.

The calculation unit 602 is configured to calculate a score of each search category domain. The score is a score of any item or a comprehensive score of multiple items of the following: similarity between the search request and the search category domain, a mass search rate of the search category domain corresponding to the search request, and an individualized user interest score of the search category domain.

The calculation unit 602 calculates the comprehensive score of each search category domain is as follows: calculating a score of a product, an average score, or a weighted score according to multiple items of the similarity between the search request and the search category domain, the mass search rate of the search category domain corresponding to the search request, and the individualized user interest score of the search category domain.

The selection unit 603 is configured to select one or more of search category domains according to the score of each search category domain.

The search unit 604 is configured to search for the search keywords by using the one or more search category domains selected by the selection unit.

According to the embodiment of the present invention, the calculation unit 602 and the selection unit 603 may also determine an individualized query classification of a user in multiple manners. For example, one or more search category domains with high similarity may be selected for a search according to the similarity between the search request and the search category domain; or, one or more search category domains with a high mass search rate may be selected for a search according to the mass search rate of the search category domain corresponding to the search request; or, one or more search category domains with a high individualized user interest score may be selected for a search according to the individualized user interest score of the search category domain. Definitely, the foregoing items may also be taken into account in a comprehensive manner to calculate the comprehensive score of each of the search category domains, and one or more search category domains with a high comprehensive score may be selected for a search. Therefore, the calculation unit 602 includes any one or more of the following units:

A similarity calculation unit, configured to calculate the similarity between the search request and each of the search category domains;

A mass search rate calculation unit, configured to calculate the mass search rate of each of the search category domains corresponding to the search request; and

A user interest score calculation unit, configured to calculate the individualized user interest score of each of the search category domains.

Detailed description is provided in the following through respective examples.

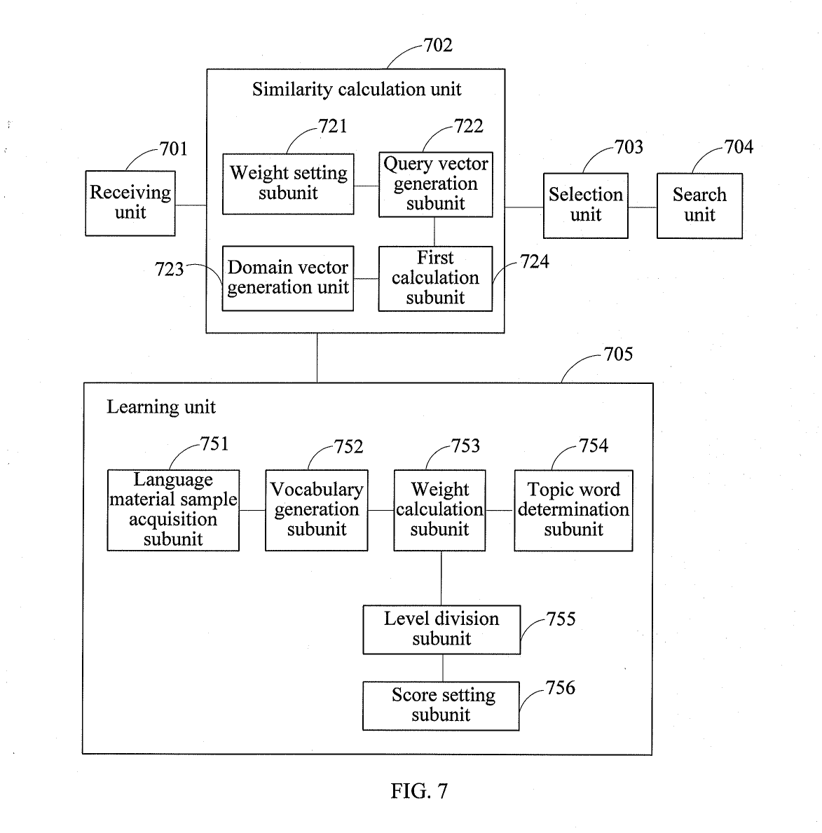

FIG. 7 is a specific schematic structural diagram of a mobile search apparatus according to an embodiment of the present invention.

In this embodiment, the apparatus includes: a receiving unit 701, a similarity calculation unit 702, a selection unit 703, and a search unit 704. The receiving unit 701, the selection unit 703, and the search unit 704 are the same as the corresponding units in the embodiment shown in FIG. 6, and therefore are not described in detail herein again.

The similarity calculation unit 702 includes: a weight setting subunit 721, a query vector generation subunit 722, a domain vector generation unit 723, and a first calculation subunit 724. The weight setting subunit 721 is configured to set weights for the search keywords. The query vector generation subunit 722 is configured to generate a query vector according to the weights of the search keywords. The domain vector generation unit 723 is configured to generate a domain vector corresponding to the search category domain according to a weight of each word of the search category domain. The first calculation subunit 724 is configured to acquire the similarity between the search request and the search category domain by calculating the query vector and the domain vector.

In this embodiment, the apparatus may further include a setting unit (not shown in FIG. 7) or a learning unit 705. The setting unit is configured to determine a topic word and a relevant word of the search category domain and a weight of each word manually. The learning unit 705 is configured to determine the topic word and the relevant word of the search category domain and the weight of each word in an automatic learning manner.

The learning unit 705 includes: a language material sample acquisition subunit 751, a vocabulary generation subunit 752, a weight calculation subunit 753, and a topic word determination subunit 754. The language material sample acquisition subunit 751 is configured to acquire a training text language material sample corresponding to each search category domain. The vocabulary generation subunit 752 is configured to perform word cutting on the language material sample to generate a vocabulary of the search category domain.

The weight calculation subunit 753 is configured to calculate a weight of each word in the vocabulary. The topic word determination subunit 754 is configured to determine the topic word and the relevant word of the search category domain according to the weight of each word.

In the embodiment of the present invention, the learning unit 705 may further include: a level division subunit 755 and a score setting subunit 756. The level division subunit 755 is configured to divide all words in the vocabulary into sets of different levels according to the weights. The score setting subunit 756 is configured to set a final score for the set of each of the levels, and use the final score of each of the levels as the weight of each of the words of the level.

In the mobile search apparatus according to the embodiment of the present invention, for the search request of the user, the similarity between the search request and each of the search category domains is calculated, and one or more search category domains with high similarity are selected for a search, so as to determine an individualized query classification for the user, and provide an individualized accurate search result for the user. For the specific process, reference can be made to the description of the embodiment shown in FIG. 2, so that the details are not described herein again.

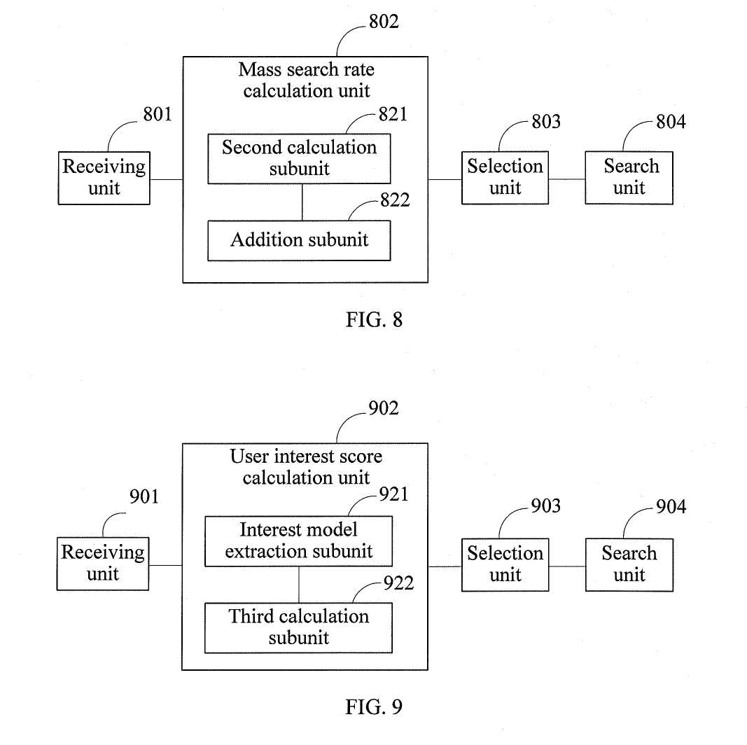

FIG. 8 is another specific schematic structural diagram of a mobile search apparatus according to an embodiment of the present invention.

In this embodiment, the apparatus includes: a receiving unit 801, a mass search rate calculation unit 802, a selection unit 803, and a search unit 804. The receiving unit 801, the selection unit 803, and the search unit 804 are the same as the corresponding units in the embodiment shown in FIG. 6, and therefore are not described in detail herein again.

The mass search rate calculation unit 802 includes a second calculation subunit 821 and an addition subunit 822. The second calculation subunit 821 is configured to calculate the mass search rate of each of the search category domains corresponding to each of the search keywords in the search request. The addition subunit 822 is configured to use a sum of the mass search rates of the same search category domain corresponding to all of the search keywords in the search request as the mass search rate of the search category domain corresponding to the search request.

In the embodiment of the present invention, the mass search rate may specifically be the number of mass searches. When the second calculation subunit 821 calculates the total number of the mass searches of a search category domain corresponding to each of the keywords in the search request, for a search request including a keyword of the search request, the total number of times of selecting a search category domain for a search by all users may be acquired according to a historical record, which is used as the total number of times of searching the search category domain by the mass corresponding to the keyword, that is, the total number of mass searches corresponding to the search category domain. Then, the addition subunit 822 uses a sum of the total numbers of mass searches of the search category domain corresponding to all of the keywords of the search request as the total number of mass searches of the search category domain corresponding to the search request.

In the embodiment of the present invention, the mass search rate may specifically be the number of mass search result clicks. When the second calculation subunit 821 calculates the total number of the mass search result clicks of a search category domain corresponding to each of the keywords in the search request, for search requests including a keyword of the search request, the total number of clicks of all users on a search result of selecting a search category domain for a search may be acquired according to a historical record, which is used as the total number of the clicks of the masses on the search result of the search category domain corresponding to the keyword, that is, the total number of mass search result clicks corresponding to the search category domain. Then, the addition subunit 822 uses a sum of the total number of the mass search result clicks of the search category domain corresponding to all of the keywords of the search request as the total number of the mass search result clicks of the search category domain corresponding to the search request.

In the mobile search apparatus according to the embodiment of the present invention, for the search request of the user, the mass search rate of each search category domain corresponding to the search request is calculated, and one or more search category domains with a high mass search rate are selected for a search, so as to determine an individualized query classification for the user, and provide an individualized accurate search result for the user. For the specific process, reference can be made to the description of the embodiment shown in FIG. 3, so that the details are not described herein again.

FIG. 9 is another specific schematic structural diagram of a mobile search apparatus according to an embodiment of the present invention.

In this embodiment, the apparatus includes: a receiving unit 901, a user interest score calculation unit 902, a selection unit 903, and a search unit 904. The receiving unit 901, the selection unit 903, and the search unit 904 are the same as the corresponding units in the embodiment shown in FIG. 6, and therefore are not described in detail herein again.

The user interest score calculation unit 902 includes an interest model extraction subunit 921 and a third calculation subunit 922. The interest model extraction subunit 921 is configured to extract a user interest model from user data. The user interest model is a vector generated by scores of multiple interest dimensions according to the user data. The third calculation subunit 922 is configured to use a sum of the scores of one or more interest dimensions of the user interest model corresponding to the search category domain as the individualized user interest score of the search category domain.

In this embodiment, the user interest model is a static interest model, or a dynamic interest model, or an interest model generated by combining the static interest model or the dynamic interest model. Therefore, the interest model extraction subunit 921 may have multiple structures.

The interest model extraction subunit 921 may include only a first extraction subunit (not shown in FIG. 9), which is configured to calculate a sum of word occurrence frequencies of all words in the user static file that belong to each interest dimension, and use the sum as a score corresponding to the interest dimension; and use scores of all of the interest dimensions as a vector to generate the user interest model.

The interest model extraction subunit 921 may only include a second extraction subunit (not shown), which is configured to calculate a sum of word occurrence frequencies of all words in clicked documents of a historical record of searches that belong to each of the interest dimensions, and use the sum as a score corresponding to the interest dimension; and use scores of all of the interest dimensions as a vector to generate the user dynamic interest model.

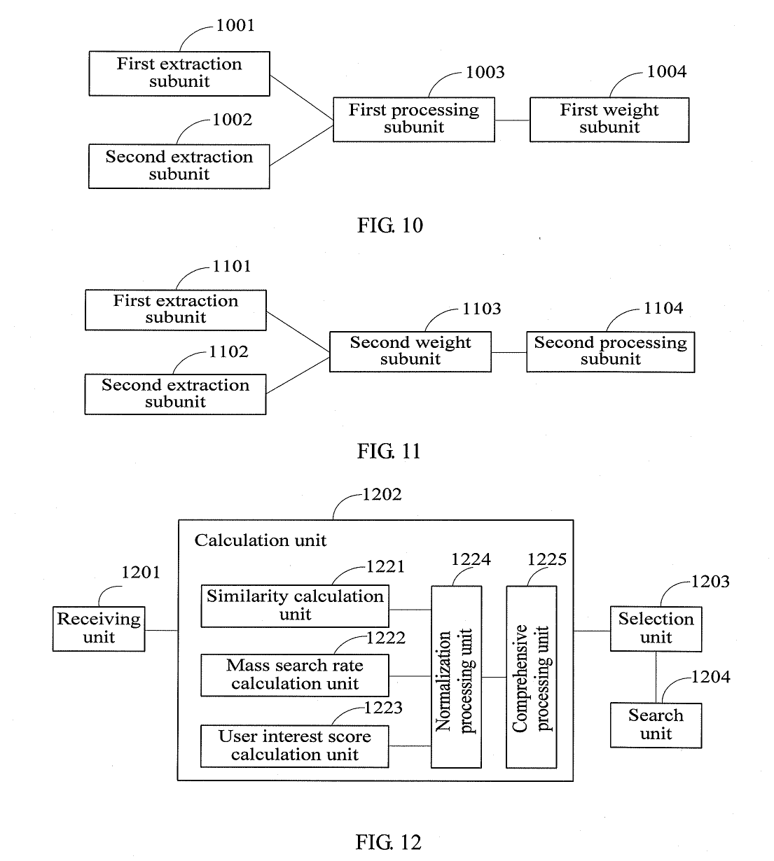

As shown in FIG. 10, the interest model extraction subunit 921 may further include a first extraction subunit 1001, a second extraction subunit 1002, a first processing subunit 1003, and a first weight subunit 1004. The first processing subunit 1003 is configured to normalize the static interest model and the dynamic interest model each. The first weight subunit 1004 is configured to calculate a sum of the normalized static interest model and the normalized dynamic interest model, and use the sum as the user interest model.

As shown in FIG. 11, the interest model extraction subunit 921 may further include a first extraction subunit 1101, a second extraction subunit 1102, a second weight subunit 1103, and a second processing subunit 1104. The second weight subunit 1103 is configured to calculate a weighted sum of the static interest model and the dynamic interest model. The second processing subunit 1104 is configured to normalize a result output by the second weight subunit, and use the normalized result as the user interest model.

In the mobile search apparatus according to the embodiment of the present invention, for the search request of the user, the individualized user interest score of each search category domain is calculated, and one or more search category domains with a high score are selected for a search, so as to determine an individualized query classification for the user, and provide an individualized accurate search result for the user. For the specific process, reference can be made to the description of the mobile search method in the embodiment of the present invention, so that the details are not described herein again.

In the mobile search apparatus according to the foregoing embodiments of the present invention, when the search category domain is selected, the similarity between the search request and the search category domain, the mass search rate of the search category domain corresponding to the search request, and the individualized user interest score of the search category domain are respectively used as a basis for selecting the search category domain, so as to determine an individualized query classification of the user, and provide an individualized accurate search result for the user.

According to an embodiment of the present invention, any two or more of the foregoing items may also be taken into account in a comprehensive manner to calculate a comprehensive score of each of the search category domains, and one or more search category domains with a high comprehensive score may be selected for a search. An embodiment of the present invention is described in detail in the following by using an example, in which the foregoing three items are taken into account in a comprehensive manner, and are used as a basis for selecting a search category domain.

FIG. 12 is another structural diagram of a mobile search apparatus according to an embodiment of the present invention.

In this embodiment, the apparatus includes: a receiving unit 1201, a calculation unit 1202, a selection unit 1203, and a search unit 1204. The receiving unit 1201 is configured to receive a search request, and the search request includes one or more search keywords. The calculation unit 1202 is configured to calculate a score of each search category domain. The score is a score of any item or a comprehensive score of multiple items of the following: similarity between the search request and the search category domain, a mass search rate of the search category domain corresponding to the search request, and an individualized user interest score of the search category domain. The selection unit 1203 is configured to select one or more of search category domains according to the score of each of the search category domains. The search unit 1204 is configured to search for the search keywords by using the one or more search category domains selected by the selection unit.

In this embodiment, the calculation unit 1202 includes: a similarity calculation unit 1221, a mass search rate calculation unit 1222, a user interest score calculation unit 1223, a normalization processing unit 1224, and a comprehensive processing unit 1225. The similarity calculation unit 1221 is configured to calculate the similarity between the search request and each of the search category domains. The mass search rate calculation unit 1222 is configured to calculate the mass search rate of each search category domain corresponding to the search request. The user interest score calculation unit 1223 is configured to calculate the individualized user interest score of each search category domain. The normalization processing unit 1224 is configured to normalize a value calculated by the similarity calculation unit, a value calculated by the mass search rate calculation unit, and a value calculated by the user interest score calculation unit respectively. The comprehensive processing unit 1225 is configured to perform comprehensive calculation on any two or more of the normalized values acquired by the normalization processing unit 1224, such as multiplying, averaging, or weighted addition, to acquire a score of each of the search category domains.

In view of the foregoing, in the mobile search apparatus according to the embodiments of the present invention, multiple factors are taken into account in a comprehensive manner to determine the individualized query classification of the user, the comprehensive score of each search category domain is calculated, and one or more search category domains with a high comprehensive score are selected for a search, thereby providing an individualized accurate search result for the user.

The embodiments of the present invention are described in detail above. The present invention is described herein through specific implementations. The description about the embodiments of the present invention is provided merely for ease of understanding of the method and apparatus of the present invention. A person skilled in the art can make variations and modifications to the present invention in terms of the specific implementations and application scopes according to the ideas of the present invention. Therefore, the specification shall not be construed as a limit to the present invention.

1. A mobile search method, comprising:
receiving a search request, wherein the search request comprises one or more search keywords;
calculating a score of each search category domain, wherein the score is a score of any item or a comprehensive score of multiple items of the following: similarity between the search request and the search category domain, a mass search rate of the search category domain corresponding to the search request, and an individualized user interest score of the search category domain; and
selecting one or more of search category domains according to the score of each search category domain to search for the search keywords.

2. The method according to claim 1, wherein the calculating the comprehensive score of each of the search category domains comprises: calculating one of a product score, an average score, and a weighted score according to multiple items of the similarity between the search request and the search category domain, the mass search rate of the search category domain corresponding to the search request, and the individualized user interest score of the search category domain.

3. The method according to claim 1, wherein the calculating the similarity between the search request and the search category domain comprises:
setting a weight for the search keywords;
generating a query vector according to the weight of the search keywords;
generating a domain vector corresponding to the search category domain by using a weight of each word of the search category domain; and
acquiring the similarity between the search request and the search category domain by calculating the query vector and the domain vector.

4. The method according to claim 3, wherein the method further comprises one of:
determining a topic word and a relevant word of the search category domain and a weight of each of the words manually; and
determining the topic word and the relevant word of the search category domain and the weight of each of the words in an automatic learning manner.

5. The method according to claim 4, wherein the determining the topic word and the relevant word of the search category domain and the weight of each of the words in the automatic learning manner comprises:
acquiring a training text language material sample corresponding to each of the search category domains;
performing word cutting on the language material sample to generate a vocabulary of the search category domain;
calculating a weight of each word in the vocabulary; and
determining the topic word and the relevant word of the search category domain according to the weight of each word.

6. The method according to claim 5, wherein the determining the topic word and the relevant word of the search category domain and the weight of each word in the automatic learning manner further comprises:
dividing all words in the vocabulary into sets of different levels according to the weight; and
setting a final score for a set of each of the levels, and using the final score of each of the levels as the weight of each word of the level.

7. The method according to claim 3, wherein the setting the weight for the search keywords comprises one of:
setting a same weight for all of the search keywords; and
setting a maximum weight for the first keyword, setting a medium weight for a middle keyword, and setting a minimum weight for a last keyword.

8. The method according to claim 1, wherein the calculating the mass search rate of the search category domain corresponding to the search request comprises:
calculating a mass search rate of each search category domain corresponding to each of the search keywords in the search request; and
using a sum of mass search rates of a same search category domain corresponding to all of the search keywords in the search request as the mass search rate of the search category domain corresponding to the search request.

9. The method according to claim 8, wherein the mass search rate is the number of mass searches or the number of mass search result clicks.

10. The method according to claim 1, wherein the calculating the individualized user interest score of the search category domain comprises:
extracting a user interest model from user data, wherein the user interest model is a vector generated by scores of multiple interest dimensions according to the user data; and
using a sum of scores of one or more interest dimensions of the user interest model corresponding to the search category domain as the individualized user interest score of the search category domain.

11. The method according to claim 10, wherein the user interest model is one of a static interest model and a dynamic interest model;
extracting the user static interest model from the user data comprises:
calculating a sum of word occurrence frequencies of all words in a user static file that belong to each of the interest dimensions, and using the sum as a score corresponding to each of the interest dimensions; or, calculating a score of similarity between the user static file and each of the interest dimensions, and using the score as a score corresponding to each of the interest dimensions; and
using a score corresponding to each of the interest dimensions as a vector to generate the user interest model; and
extracting the user dynamic interest model from the user data comprises:
calculating a sum of word occurrence frequencies of all words in a historical record of searches and clicks of a user that belong to each of the interest dimensions, and using the sum as a score corresponding to each of the interest dimension; or calculating a score of similarity between the historical record of searches and clicks and each of the interest dimensions, and using the score as a score corresponding to each of the interest dimension; and
using a score of each of the interest dimensions as a vector to generate the user dynamic interest model.

12. The method according to claim 11, wherein the extracting the user interest model from the user data further comprises:
normalizing the static interest model and the dynamic interest model respectively; and
calculating a sum of one or more normalized static interest models and one or more normalized dynamic interest models, and using the sum as the user interest model.

13. The method according to claim 11, wherein the extracting the user interest model from the user data further comprises:
calculating a weighted sum of one or more static interest models and one or more dynamic interest models; and
normalizing the weighted sum, and using a normalized result as the user interest model.

14. The method according to claim 1, wherein the calculating the weighted score of each of the search category domains comprises:
calculating the similarity between the search request and the search category domain, and normalizing the similarity;
calculating the mass search rate of the search category domain corresponding to the search request, and normalizing the mass search rate;
calculating the individualized user interest score of the search category domain, and normalizing the individualized user interest score; and
calculating a weighted sum of any two or more of the normalized values to acquire the weighted score of the search category domain.

15. A mobile search apparatus, comprising:
a receiving unit, configured to receive a search request, wherein the search request comprises one or more search keywords;
a calculation unit, configured to calculate a score of each search category domain, wherein the score is a score of any item or a comprehensive score of multiple items of the following: similarity between the search request and the search category domain, a mass search rate of the search category domain corresponding to the search request, and an individualized user interest score of the search category domain;
a selection unit, configured to select one or more of search category domains according to the score of each of the search category domains; and
a search unit, configured to search for the search keywords by using the one or more search category domains selected by the selection unit.

16. The apparatus according to claim 15, wherein the calculating, by the calculation unit, the comprehensive score of each of the search category domains comprises: calculating one of a score of a product, an average score, and a weighted score according to multiple items of the similarity between the search request and the search category domain, the mass search rate of the search category domain corresponding to the search request, and the individualized user interest score of the search category domain.

17. The apparatus according to claim 15, wherein the calculation unit comprises any one or more of the following units:
a similarity calculation unit, configured to calculate the similarity between the search request and each of the search category domains;
a mass search rate calculation unit, configured to calculate the mass search rate of each of the search category domains corresponding to the search request; and
a user interest score calculation unit, configured to calculate the individualized user interest score of each of the search category domains.

18. The apparatus according to claim 17, wherein the similarity calculation unit comprises:
a weight setting subunit, configured to set a weight for the search keywords;
a query vector generation subunit, configured to generate a query vector according to the weight of the search keywords;
a domain vector generation unit, configured to generate a domain vector corresponding to the search category domain according to a weight of each word of the search category domain; and
a first calculation subunit, configured to acquire the similarity between the search request and the search category domain by calculating the query vector and the domain vector.

19. The apparatus according to claim 18, wherein the apparatus further comprises:
a setting unit, configured to determine a topic word and a relevant word of the search category domain and a weight of each of the words manually; or
a learning unit, configured to determine the topic word and the relevant word of the search category domain and the weight of each of the words in an automatic learning manner.

20. The apparatus according to claim 19, wherein the learning unit comprises:
a language material sample acquisition subunit, configured to acquire a training text language material sample corresponding to each of the search category domains;
a vocabulary generation subunit, configured to perform word cutting on the language material sample to generate a vocabulary of the search category domain;
a weight calculation subunit, configured to calculate a weight of each word in the vocabulary; and
a topic word determination subunit, configured to determine the topic word and the relevant word of the search category domain according to the weight of each word.
